(19) United States
(12) Patent Application Publication
(10) Pub. No.: US 2025/0338095 A1
(43) Pub. Date: Oct. 30, 2025

(54) INTEGRATED WIRELESS PLATFORM

(71) Applicant: Saudi Arabian Oil Company, Dhahran (SA)

(72) Inventors: Soloman M. Almadi, Dhahran (SA); Abdelghani A. Daraiseh, Dhahran (SA)

(21) Appl. No.: 18/644,794

(22) Filed: Apr. 24, 2024

(51) Int. Cl. H04W 4/18; H04W 84/12

(52) U.S. Cl. CPC H04W 4/18; H04W 84/12

(57) ABSTRACT

A system is provided. The system includes a plurality of wireless access points (WAPs) corresponding to a plurality of wireless communication protocols. The system includes a wireless local network server coupled to the plurality of WAPs via a communication bus. The wireless local network server is configured to convert data under the plurality of wireless communication protocols to data under a local protocol. The system includes a data diode communicatively coupled to the communication bus. The system includes a processor configured to control the data diode to exchange the data under the local protocol between the plurality of WAPs. Also provided is a method and an apparatus.

### TECHNICAL FIELD

The disclosure relates to systems and methods for managing an integrated wireless platform.

### BACKGROUND

A wireless communications network enables computing devices to exchange information with one another via one or more wireless communications links. As an example, a computing device can transmit information intended for another computing device by encoding the information in a wireless signal and broadcasting the wireless signal into the ambient environment. Network equipment (such as a wireless access point or a wireless router) can receive the wireless signal from the ambient environment, decode the wireless signal to extract the information, and route the information to the intended computing device. As another example, the network equipment can receive information intended for a computing device, encode the information in a wireless signal, and broadcast the wireless signal into the ambient environment. The computing device can receive and decode the wireless signal to extract the information.

### SUMMARY

This disclosure describes an integrated wireless platform. The platform integrates wireless access points (WAPs) corresponding to a plurality of wireless communication protocols and allows the WAPs to exchange data under different wireless communication protocols subject to data flow control by a data diode. The platform provides enables effective intercommunications across wireless technologies and network functions with increased hardware integration and reduced manufacturing and maintenance cost.

In one aspect according to the present disclosure, a system is provided. The system includes a plurality of WAPs corresponding to a plurality of wireless communication protocols. The system includes a wireless local network server coupled to the plurality of WAPs via a communication bus. The wireless local network server is configured to convert data under the plurality of wireless communication protocols to data under a local protocol. The system includes a data diode communicatively coupled and/or integrated to the communication bus. The system includes a processor configured to control the data diode to exchange the data under the local protocol between the plurality of WAPs.

In another aspect according to the present disclosure, a method is provided. The method includes communicating, via a communication bus, data under a plurality of wireless communication protocols between a wireless local network server and a plurality of WAPs. The method includes converting, via the wireless local network server, the data under the plurality of wireless communication protocols to data under a local protocol. The method includes controlling a data diode to exchange the data under the local protocol between the plurality of WAPs.

In another aspect according to the present disclosure, an apparatus is provided. The apparatus includes a wireless local network server coupled to a plurality of WAPs via a communication bus. The plurality of WAPs correspond to a plurality of wireless communication protocols. The wireless local network server is configured to convert data under the plurality of wireless communication protocols to data under a local protocol. The apparatus includes a data diode communicatively coupled to the communication bus. The apparatus includes a processor configured to control the data diode to exchange the data under the local protocol between the plurality of WAPs.

The details of one or more implementations are set forth in the accompanying drawings and the description. Other features and advantages will be apparent from the description and drawings, and from the claims.

### BRIEF DESCRIPTION OF DRAWINGS

FIG. 1 is a diagram of an example system that enables information to be exchanged wirelessly between several computing devices.

FIG. 2 is a diagram of an example wireless network management system.

FIGS. 3A and 3B are diagrams of example graphical network maps.

FIG. 4 is a diagram of an example system for managing wireless devices in multiple locations.

FIG. 5 illustrates a system architecture of an example integrated wireless platform.

FIG. 6 illustrates example data flows between a data diode and a plurality of network servers.

FIG. 7 illustrates an architecture of an example integrated wireless platform implemented with a power management module and an antenna tower.

FIG. 8 is a flowchart of an example method.

FIG. 9 is a schematic diagram of an example computer system.

### DETAILED DESCRIPTION

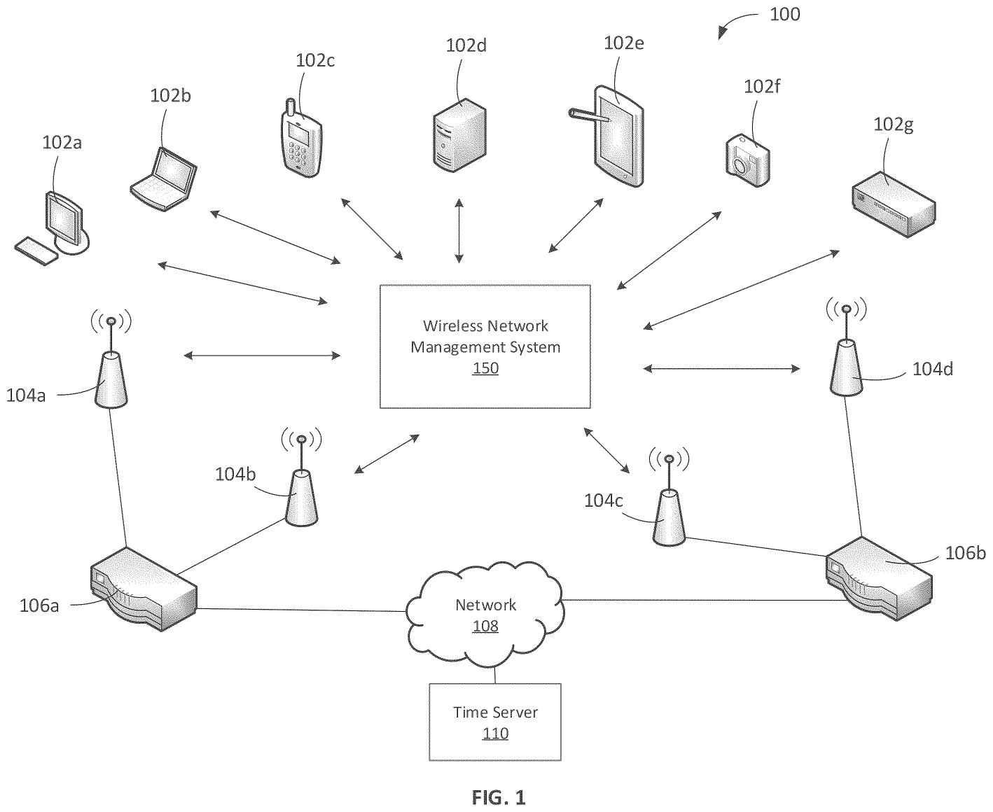

FIG. 1 shows an example system 100 that enables information to be exchanged wirelessly between several computing devices 102a-102g (each individually referred to as computing device 102). The system 100 includes the computing devices 102a-102g, several WAPs 104a-104d (each individually referred to as WAP 104), several routers 106a and 106b communicatively coupled to one another via a network 108, and a wireless network management system 150. Collectively, the system 100 can form a wireless communications network, such as a Wi-Fi network.

During an example operation of the system 100, each of the computing devices 102a-102g establishes one of more wireless communications links with one or more of the WAPs 104a-104d. Each of the computing devices 102a-102g can transmit information to other ones of the computing devices 102a-102g (or other devices communicatively coupled to the network 108) via the wireless communications links. For example, a computing device 102 encodes information in a wireless signal, and transmits the wireless signal over a wireless link to one of the WAPs 104a-104d. The WAP 104 receives the wireless signal, decodes the wireless signal to extract the information, and provides the information to a router 106a or 106b. The router 106a or 106b determines the intended destination of the information, and routes the information to the intended destination (for example, via the network 108, other routers 106a or 106b, and WAPs 104a-104d).

Further, each of the computing devices 102a-102g can receive information from other ones of the computing devices 102a-102g (or other devices communicatively coupled to the network 108) via the wireless communications links. For example, a router 106a or 106b receives information intended for a particular computing device 102 and routes the information to one or more of the WAPs 104a-104d in proximity to the intended computer device 102a-102g. The WAP 104 encodes the information in a wireless signal, and transmits the wireless signal into an environment of the intended computing device 102. The intended computing device 102 receives the wireless signal, and decodes the wireless signal to extract the information.

Further, the system 100 includes a wireless network management system 150 configured to manage each of the other devices of the system 100. For instance, the wireless network management system 150 can retrieve information regarding each of the computing devices 102a-102g, WAPs 104a-104d, routers 106a and 106b, or any of the devices of the network 108, and present the information to a user for review. As an example, the wireless network management system 150 can determine the identities, locations, and network configurations of each of these devices, and present a graphical user interface that displays at least some of this information to a user. This can be useful, for example, in enabling the user to better understand how the system 100 has been configured and deployed in a particular environment.

In some implementations, the wireless network management system 150 can automatically retrieve or access information regarding one of the devices of the system 100. For example, the wireless network management system 150 can be communicatively coupled to one of the devices of the system 100 via wireless and/or wired communications links, and automatically retrieve information regarding each of the devices directly from those devices. As another example, the wireless network management system 150 can be communicatively coupled to a database that stores information regarding one or more of the devices of the system 100, and automatically retrieve information regarding each of the devices directly from the database.

In some implementations, the wireless network management system 150 can obtain information regarding one of the devices of the system 100 based on manual input from a user. For example, the wireless network management system 150 can present a graphical user interface to a user with data entry fields, selectable elements, or other interactive elements that enable a user to provide information regarding one or more of the devices to the wireless network management system 150

Further, the wireless network management system 150 can determine, based on the retrieved information, one or more modifications to the devices of the system 100 to improve the performance of the system 100. For example, the wireless network management system 150 can determine that the system 100 can be improved by moving one or more of the devices to different locations or modifying the network configuration of more or more of the devices.

This can be beneficial, for example, in improving the performance of a system 100. As an example, the wireless network management system 150 can be used to modify the configuration of a system 100 to improve the speed by which data is transmitted between devices wirelessly, enhance the communications range of the system 100, eliminate or otherwise reduce coverage gaps in the system 100, and increase the overall reliability of the system 100.

In some implementations, can automatically perform these modifications. For example, the wireless network management system 150 can generate commands to modify the network configuration of one or more of the devices, and transmit the command to the appropriate devices for execution (for example, via one or more wired and/or wireless links).

In some implementations, the wireless network management system 150 can present proposed modifications to a user and guide the user in performing the modifications manually. For example, the wireless network management system 150 can present a graphical user interface that includes instructions to relocate a particular device from one location to another. As another example, the wireless network management system 150 can present a graphical user interface that includes instructions to modify a network configuration of a particular device.

In some implementations, the wireless network management system can be implemented as one or more stand-alone computer “appliances.” For example, a computer appliance can be pre-configured (for example, during a manufacturing or production process) to perform particular operations for managing devices on a wireless communications network, such that those described in further detail below. A user can deploy the computer appliance by positioning the device in an operating environment having a wireless communication network, and providing power and network connectivity of the computer appliance. Upon deployment, the computer appliance can automatically perform at last some of the pre-configured operations, without requiring that a user manually install additional software or hardware. This can be beneficial, for example, as it enables the wireless network management system 150 to be deployed in an automated and “plug and play” manner, without requiring that a user perform a complex or tedious installation process.

Example operations of the wireless network management system 150 are described in further detail below.

The computing devices 102a-102g can include any number of electronic devices that are configured to receive, process, and transmit data wirelessly. Examples of the computing devices 102a-102g include client computing devices (such as desktop computers or notebook computers), server computing devices (such as server computers or cloud computing systems), mobile computing devices (such as cellular phones, smartphones, tablets, personal data assistants, notebook computers with networking capability), wearable computing devices (such as a smart phone or a headset), cameras, sensors, network-enabled industrial equipment or machinery, network-enabled appliances, or any other devices capable of receiving, processing, and transmitting data wirelessly.

Further, in some implementations, at least some of the computing devices 102a-102g can be Internet of Things (IoT) devices and/or Industrial Internet of Things (IIoT) devices. For example, at least some of the computing devices 102a-102g can include sensors, instruments, and other devices that are networked together to perform industrial processes, such as manufacturing and energy management. As another example, at least some of the computing devices 102a-102g can facilitate the performance of industrial processes in the fields of petrochemical exploration and processing, energy production, manufacturing, agriculture, automobiles, aviation, or any other industry. In some implementations, the computing devices 102a-102g can be deployed in a strictly industrial setting (for example, a factory or industrial plant), rather than in home or administrative office settings. In some implementations, the computing devices 102a-102g can be deployed in multiple settings concurrently, such as a combination of industrial, home, and/or administrative office settings. Further, the computing devices 102a-102g can be deployed in indoor settings, outdoor settings, or both.

In some implementations, the computing devices 102a-102g can include devices that operate using one or more operating systems (as examples, Microsoft Windows, Apple macOS, Linux, Unix, Google Android, and Apple IOS, among others) and one or more architectures (as examples, x86, PowerPC, and ARM, among others). In some implementations, one or more of the computing devices 102a-102g need not be located locally with respect to the rest of the system 100, and one or more of the computing devices 102a-102g can be located in one or more remote physical locations.

In some implementations, a computing device 102 can include a wireless transceiver (for example, having one or more wireless radios and antennas) to transmit wireless to and receive wireless signals from the ambient environment. For example, a wireless transceiver can be used to transmit data wirelessly to a nearby WAP 104. As another example, a wireless transceiver can be used to receive data wireless from a nearby wireless access 104b. In some implementations, the wireless transceivers can operate in accordance with one or more technical standards. For example, the wireless transceivers can operate in accordance with one or more Wi-Fi technical standards, as defined by the Institute of Electrical and Electronics Engineers. Example W-Fi technical standards include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, IEEE 802.11ay, IEEE 802.11ba, and IEEE 802.11be, among others. In some implementations, the wireless transceivers can include narrowband radio systems, broadband wireless system, systems that facilitate formation of low power wireless networks, or a combination of two or more of these systems.

The WAPs 104a-104d are networking hardware devices that are configured to form wireless communications links between one of the computing devices 102a-102g and other networking equipment (for example, the wireless network management system 150, a router 106a or 106b, or other devices of the network 108). In some implementations, a WAP 104 can include a wireless transceiver (for example, having one or more wireless radios and antennas) to transmit and receive wireless signals from the ambient environment. For example, a wireless transceiver can be used to transmit data wirelessly to the wireless network management system 150 and/or nearby a computing device 102. As another example, a wireless transceiver can be used to receive data wirelessly from the wireless network management system 150 and/or a nearby computing device 102. In some implementations, the wireless transceivers can operate in accordance with one or more technical standards. For example, the wireless transceivers can operate in accordance with one or more Wi-Fi technical standards, as defined by the Institute of Electrical and Electronics Engineers. Example W-Fi technical standards include IEEE 802.11a, IEEE 802.11b, IEEE 802.11g, IEEE 802.11n, IEEE 802.11ac, IEEE 802.11ad, IEEE 802.11 af, IEEE 802.11ah, IEEE 802.11ai, IEEE 802.11aj, IEEE 802.11aq, IEEE 802.11ax, IEEE 802.1 lay, IEEE 802.11ba, and IEEE 802.11be, among others.

The routers 106a and 106b are network hardware devices that are configured to direct data traffic between devices of the system 100. As an example, a router can receive data intended for a particular device, ascertain the intended destination of the data, and direct the data to the intended device (or one or more intermediary devices) to facilitate the delivery of the data to the intended destination. In some implementations, a router can be communicatively coupled to other devices of the system 100 (for example, the wireless network management system 150, the WAPs 104a-104d, other routers, and/or the network 108) via one or more wired and/or wireless connections.

The network 108 can be any communications network through which data can be transferred and shared. For example, the network 108 can be a local area network (LAN) or a wide-area network (WAN), such as the Internet. The network 108 can be implemented using various networking interfaces, for instance wireless networking interfaces (such as Wi-Fi, Bluetooth, or infrared) or wired networking interfaces (such as Ethernet or serial connection). The network 108 also can include combinations of more than one network, and can be implemented using one or more networking interfaces.

In some implementations, the network 108 can include network hardware equipment to facility the transfer and sharing of data. Example network hardware includes routers, switches, gateways, bridges, repeaters, repeater hubs, access points, servers, firewalls, modem, and line drivers.

In some implementations, some or all of the devices of the system 100 can operate in accordance with one or more uniform timing sources. For example, the internal clocks of some or all of the devices of the system 100 can be synchronized using a time server 110, such that the devices transmit, receive, and/or process data according to a common clock. In some implementations, a time server 110 can be included as a part of the network 108, or as another device (for example, a stand-alone computer server that is communicatively coupled to one or more of the devices of the system 100).

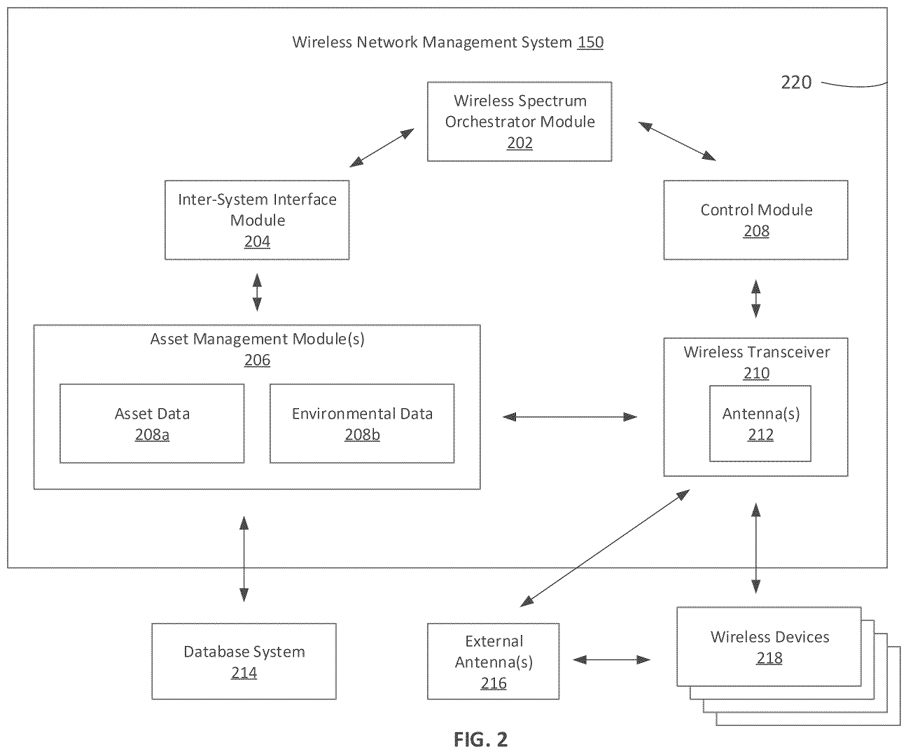

FIG. 2 shows the wireless network management system 150 in greater detail. The wireless network management system 150 includes a wireless spectrum orchestrator module 202, an inter-system interface module 204, an asset management module 206, a control module 208, and a wireless transceiver 210. Each of the modules 202, 204, 206, 208, and 210 can be implemented as one or more groups of digital electronic circuitry, computer software, firmware, or hardware, or in combinations of one or more of them.

As described above, the wireless network management system 150 can be implemented as one or more stand-alone computer “appliances.” For example, some or all of the modules 202, 204, 206, 208, and 210 can be enclosed within a common housing or enclosure 220, such that the wireless network management system 150 is provided as a single physical device that can be readily deployed to a particular location and re-located to different locations. Further, each of the modules 202, 204, 206, 208, and 210 can be pre-configured (for example, during a manufacturing or production process for the wireless network management system 150) to perform particular operations for managing devices on a wireless communications network. A user can deploy the wireless network management system 150 by positioning the wireless network management system 150 in an operating environment having a wireless communication network, and providing power and network connectivity of the wireless network management system 150. Upon deployment, the wireless network management system 150 can automatically perform at least some of the pre-configured operations, without requiring that a user manually install additional software or hardware. In some implementations, upon being switched or powered on, the wireless network management system 150 can automatically perform at least some of the pre-configured operations on a continuous basis (for example, according to a repeating or periodic schedule over an extended interval of time, such as hours, days, weeks, months, or years) unless powered down or instructed by a user to terminate the operations.

During an example operation of the wireless network management system 150, the asset management module 206 collects asset data 208a regarding each of the wireless devices 218 in an environment (for example, an environment of the wireless network management system 150).

As an example, asset data 208a for a wireless device 218 can include identifying information for the wireless device 218. For instance, asset data 208a for a wireless device 218 can include a unique identifier associated with the wireless device 218. As another example, asset data 208a for a wireless device 218 can indicate a system type, of the wireless device 218 (for example, whether the device is a Wireless Protocol International Society of Automation (ISA) 100.11a device, a wireless Highway Addressable Remote Transducer Protocol (HART) device, or a Bluetooth device As further examples, asset data 208a for a wireless device 218 can indicate of a manufacturer of the wireless device 218, a model number of the wireless device 218, a software version of the wireless device 218, and a project number associated with the wireless device 218. As another example, asset data 208a for a wireless device 218 can indicate an application type related to a process application for controlling and/or monitoring the wireless device 218.

As further examples, asset data 208a for a wireless device 218 can include information regarding a network configuration of the wireless device 218. For instance, asset data 208a for a wireless device 218 can include a media access control (MAC) address of the wireless device 218, an internet protocol (IP) address of the wireless device 218, a wireless operating frequency of the wireless device 218 (for example, a frequency with which the wireless device 218 is broadcasting and/or receiving wireless signals), and a wireless frequency channel of the wireless device 218 (for example, a channel with which the wireless device 218 is broadcasting and/or receiving wireless signals).

As further examples, asset data 208a for a wireless device 218 can include information regarding one or more antennas of the wireless device 218. For instance, asset data 208a for a wireless device 218 can include an indication of the type of the antenna, a direction or orientation of an antenna, and a pole height of the antenna.

As further examples, asset data 208a for a wireless device 218 can include information regarding a location at which the wireless device 218 is deployed or installed. For instance, asset data 208a for a wireless device 218 can include an indication of the site at which the wireless device 218 installed (for example, a particular building or facility), an indication of the zone of the facility in which the wireless device 218 installed (for example, a particular floor, wing, or room of a building), and an indication of the precise location at which the wireless device 218 installed (for example, geographical coordinates).

In some implementations, the wireless devices 218 can store information regarding themselves, and the asset management module 206 can obtain at least some of the asset data 208a from each of the wireless devices 218 directly. For example, the asset management module 206 can be communicatively coupled to one or more of the wireless devices 218 though a wireless transceiver 210 that includes an internal antenna 212 and/or is communicatively coupled to an external antenna 216. The wireless transceiver 210 can transmit a command to each of the wireless devices 218 to respond with information regarding that wireless device 218 (for example, a command to a wireless device 218 to transmit wireless signals that include information stored by that wireless device 218). Further, the wireless transceiver 210 can receive the response from the wireless device 218, and provide the information to the asset management module 206.

In some implementations, the asset management module 206 can determine at least some of the asset data 208a based on the characteristics of wireless signals transmitted by each of the wireless devices 218. For example, the asset management module 206 can use the wireless transceiver 210 to determine the strength of wireless signals transmitted by each of the wireless devices 218 and the direction from which the wireless signals were transmitted. Based on this information, the asset management module 206 can estimate the location of each of the wireless devices 218, such as by signal triangulation or other techniques. As another example, the asset management module 206 can determine the network configurations of the wireless devices 218 based on wireless signals transmitted by the wireless devices 218. For example, based on the wireless signals transmitted by the wireless devices 218, the asset management module 206 can determine MAC address of the wireless device 218, an IP address of the wireless device 218, an operating frequency of the wireless device 218, and/or a frequency channel of the wireless device 218. In some implementations, the asset management module 206 can determine at least some of this information based on a spectral analysis of the wireless signals in the environment.

In some implementations, a database system 214 external to the wireless network management system 150 can store information regarding at least some of the wireless devices 218, and the asset management module 206 can obtain at least some of the asset data 208a from the database system 214. In some implementations, the information stored in the database system 214 can be obtained from the wireless devices 218 and/or determined based on wireless signals transmitted by the wireless devices 218. In some implementations, the information stored in the database system 214 can be manually input by one or more users (for example, via a graphical user interface provided by the database system 214).

In some implementations, a user can manually input at least some of the asset data 208a into the wireless network management system 150 (for example, via a graphical user interface provided by the wireless network management system 150).

During an example operation of the wireless network management system 150, the asset management module 206 also collects environmental data 208b regarding the environment of the wireless devices 218.

As an example, environmental data 208b can include information regarding the floor plan or physical configuration of the environment. For example, the environmental data 208b can indicate the location and orientation of one or more physical structures within the environment, such as walls, doors, windows, pipes, conduits, rooms, items of furniture, and/or machinery (for example, electromechanical machinery) in the environment. In some implementations, the location and orientation of a physical structure can be expressed, at least in part, according to a reference coordinate frame (for example, geographical coordinates). In some implementations, the location and orientation of a physical structure can be expressed, at least in part, according to logical divisions of a building (for example, a floor of a building, plant, factory, or facility). In some implementations, the location and orientation of a physical structure can be expressed, at least in part, relative to those of another physical structure and/or the wireless devices 218. Further, the environmental data 208b can indicate the physical dimensions of the physical structures, such as the height, width, thickness, and shape of each of the physical structures.

In some implementations, the database system 214 external to the wireless network management system 150 can store information regarding the environment, and the asset management module 206 can obtain at least some of the environmental data 208b from the database system 214. In some implementations, the information stored in the database system 214 can be obtained from one or more floor plans or computer aided design (CAD) models of the physical environment. In some implementations, the information stored in the database system 214 can be manually input by one or more users (for example, via a graphical user interface provided by the database system 214).

In some implementations, a user can manually input at least some of the environmental data 208b into the wireless network management system 150 (for example, via a graphical user interface provided by the wireless network management system 150).

Although FIG. 2 depicts the wireless network management system 150 as having a single asset management module 206, this need not always be the case. For example, in some implementations, the wireless network management system 150 can include multiple asset management modules 206, each configured to obtain information regarding different groups of wireless devices 218 and/or environments.

The wireless network management system 150 also includes an inter-system interface module 204 configured to exchange data between the asset management module 206 and the wireless spectrum orchestrator module 202. In some implementations, the inter-system interface module 204 can be configured to exchange data according to one or more interfaces or protocols, such as Simple Network Management System (SNMP), Object Linking & Embedding for Process Control (OPC), Server-to-Server communications, relational databases, and Asset Management Systems among others. In some implementations, the inter-system interface module 204 can be compatible with protocols such as Modbus or Distributed Network Protocol 3 (DNP3) to facilitate the exchange of data.

In some implementations, the inter-system interface module 204 can be configured to exchange data between the asset management module 206 and the wireless spectrum orchestrator module 202 in real-time or substantially real time. In some implementations, the inter-system interface module 204 can be configured to exchange data between the asset management module 206 and the wireless spectrum orchestrator module 202 according to a recurring or periodic schedule. In some implementations, the inter-system interface module 204 can be configured to exchange data between the asset management module 206 and the wireless spectrum orchestrator module 202 in response to a command to do so, for example a command issued by a user or the wireless spectrum orchestrator module 202.

The wireless spectrum orchestrator module 202 receives data from the inter-system interface module 204, and processes the data to facilitate management of the wireless devices 218.

In some implementations, the wireless spectrum orchestrator module 202 can process the data received from the inter-system interface module 204, and present at least some of the processed data to a user for review. As an example, the wireless spectrum orchestrator module 202 can generate a graphical user interface that includes information regarding one or more of the wireless devices 218 (for example, at least a portion of the asset data 208a) and/or information regarding the environment of the wireless devices 218 (for example, at least a portion of the environmental data 208b).

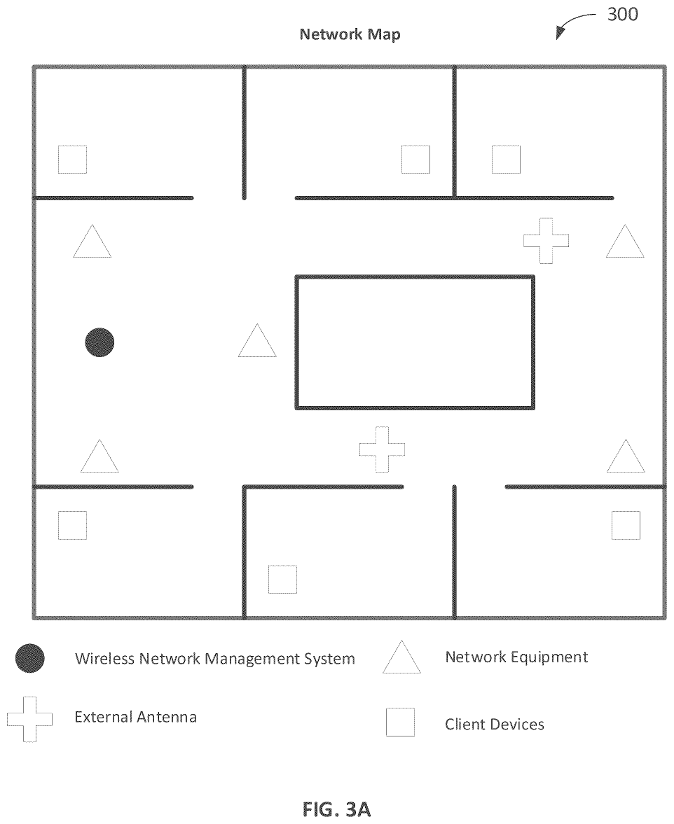

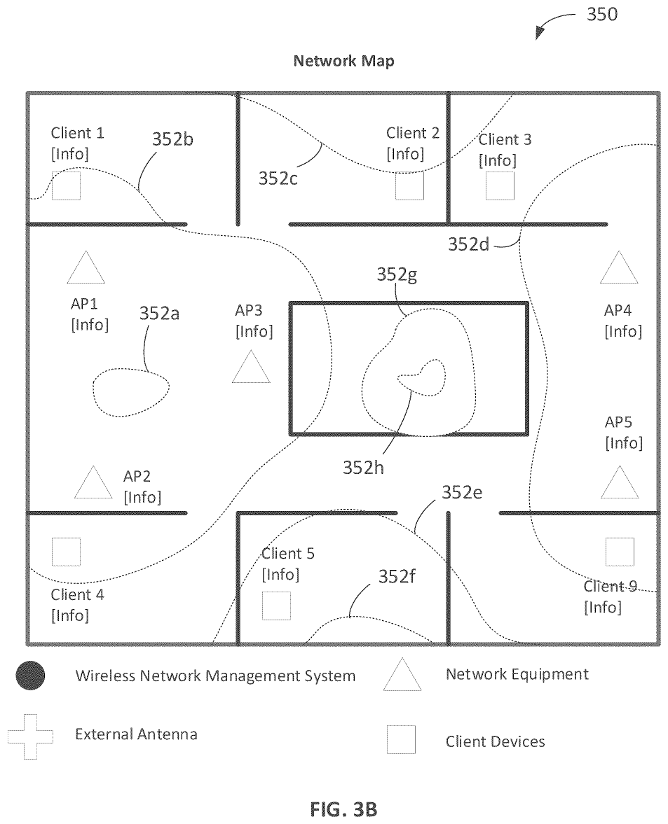

In some implementations, the wireless spectrum orchestrator module 202 can generate a graphical network map depicting the wireless devices 218 within the environment. As an example, FIG. 3A shows a graphical network map 300 that depicts the location of each of the wireless devices 218 of a wireless network in the environment, including the wireless network management system 150, network equipment (for example, WAPs 104a-104d, routers 106a and 106, or other devices in the network 108), client devices (for example, computing devices 102a-102g), and external antennas 216. Further, the graphical network map 300 depicts locations, orientations, and physical dimensions of each of the physical structures in the environment, such as walls, doors, windows, pipes, conduits, rooms, items of furniture, and/or machinery in the environment.

In some implementations, a graphical network map can be generated in real-time or substantially real-time, such that it reflects the current conditions of each of the wireless devices of the wireless network. Further, some implementations, a user can “drill down” to specific devices or locations (for example, by zooming into particular portion of the graphical network map) to review information regarding a sub-set of the wireless devices and/or a portion of the overall environment.

In some implementations, the wireless spectrum orchestrator module 202 can generate a graphical network map that includes an overlay with additional information regarding the wireless devices 218 and/or the environment. As an example, FIG. 3B shows another graphical network map 350 that depicts the location of each of the wireless devices 218 of a wireless network in the environment, as well as the locations, orientations, and physical dimensions of each of the physical structures in the environment. Further, graphical network map 350 includes overlays alongside each of the wireless devices indicating further information regarding that wireless device (for example, the identity of the wireless device and additional information regarding the wireless device, such as some or all of the asset data 208a corresponding to the wireless device). In some implementations, a user can select one of the wireless devices to obtain further information regarding the selected wireless device (for example, further information from the asset data 208a).

Further, the graphical network map 350 can include an overlay showing one or more contour lines or zones that indicate a signal coverage or signal strength of the access points of the wireless communications network (for example, the WAPs 104a-104d). As an example, the contour lines 352a-352d can indicate the signal strength of wireless signals transmitted by the access points across the environment (for example, by indicating contiguous locations having equal or approximately equal signal strengths), or gaps in signal coverage of the access points.

In some implementations, a graphical network map can be generated according to two-dimensional perspective (for example, a top-down perspective). In some implementations, a graphical network map can be generated according to three-dimensional perspective. In some implementations, a graphical network map can be generated according to four or more dimensional perspective (for example, three spatial dimensions, a time dimension, and/or one or more other dimensions of data).

Graphical network maps can be beneficial, for example, in enabling a user to better understand the configuration of the wireless devices of a wireless communications network. For example, the graphical network map can be generated such that it resembles the actual appearance of a particular environment, including to scale presentations of the structures of a building, the logical division of the building, and the devices that are located in the building. Based on a graphical network map, a user can intuitively determine the location of each of the wireless devices within the network environment and identify potential problems with the deployment of the wireless devices (for example, poor or non-existent signal coverage).

In some implementations, the wireless spectrum orchestrator module 202 can continuously obtain information regarding the wireless devices and/or the environment, and continuously update the graphical network map based on the obtained information. For example, the wireless spectrum orchestrator module 202 can obtain information regarding the wireless devices and/or the environment according to a repeating or periodic schedule over an extended interval of time (for example, hours, days, weeks, months, or years), and update the graphical network map according to a repeating or periodic schedule based on the obtained information.

In some implementations, the wireless spectrum orchestrator module 202 can process the data received from the inter-system interface module 204, and determine one or more modifications to the configurations of the wireless devices 218 to improve the performance of the wireless communication network.

As an example, based on information received from the inter-system interface module 204, the wireless spectrum orchestrator module 202 can determine the wireless operating frequencies of each of the wireless devices 218 (for example, the frequencies with which the wireless devices 218 are broadcasting and/or receiving wireless signals) and/or the wireless frequency channels of each of the wireless devices 218 (for example, the channels with which the wireless devices 218 are broadcasting and/or receiving wireless signals). Further, the wireless spectrum orchestrator module 202 can determine whether one or more of the wireless devices 218 should be assigned different wireless operating frequencies and/or a wireless frequency channels for use. For example, if a particular wireless frequency and/or channel has been assigned for use to too many wireless devices 218 in a particular location (for example, greater than a particular threshold number), the wireless spectrum orchestrator module 202 can determine that one or more of the wireless devices 218 should be assigned a different wireless frequency and/or channel for use instead. In some implementations, the wireless spectrum orchestrator module 202 can determine that the wireless devices 218 at a particular location should be assigned to particular set of wireless frequencies and/or channels, such that the assignments are evenly distributed across a particular wireless spectrum (for example, a wireless spectrum available for use for Wi-Fi communications). This can be beneficial, for example, in reducing congestion on the wireless communications network, improving the reliability of the wireless communications network, and/or increasing the data throughput across the wireless communications network.

As another example, based on information received from the inter-system interface module 204, the wireless spectrum orchestrator module 202 can determine the network addresses of each of the wireless devices 218 (for example, the IP addresses of the wireless devices 218). Further, the wireless spectrum orchestrator module 202 can determine whether one or more of the wireless devices 218 should be assigned different network address. For example, if two wireless devices 218 can be assigned the same network address, the wireless spectrum orchestrator module 202 can determine that the network address for at least one of the wireless devices 218 should be modified. This can be beneficial, for example, in reducing misconfigurations on the wireless communications network.

As another example, based on information received from the inter-system interface module 204, the wireless spectrum orchestrator module 202 can determine the location of each of the wireless devices 218 relative to one another. Further, the wireless spectrum orchestrator module 202 can determine whether one or more of the wireless devices 218 should be re-located to a different location to improve their performance. This can be beneficial, for example, in enhancing the signal coverage of the wireless communications network and improving the reliability of the wireless communications network.

For example, if a particular WAP 104 does not adequately provide signal coverage to one or more computing devices 102a-102g, the wireless spectrum orchestrator module 202 can determine a new location for the WAP 104 that provides different signal coverage.

As another example, if a particular computing device 102 is out of range of any WAPs 104a-104d, the wireless spectrum orchestrator module 202 can determine a new location for the computing device 102 that is in range of a WAP 104.

As another example, if two WAPs 104a-104d are sufficiently close to one another, such that they provide redundant or substantially overlapping signal coverage, the wireless spectrum orchestrator module 202 can determine a new location for one of the WAPs 104a-104d that provides signal coverage having less of an overlap or redundancy.

As another example, the wireless spectrum orchestrator module 202 can determine optimal locations for several WAPs 104a-104d to deploy a “mesh” wireless network configuration. For instance, the wireless spectrum orchestrator module 202 can determine locations for each of the WAPs 104a-104d, such that each the WAPs 104a-104d in range of one or more other WAPs 104a-104d. This enables the WAPs 104a-104d to form wireless communications links between them according to a mesh arrangement.

As another example, the wireless spectrum orchestrator module 202 can determine that one or more physical structures are blocking a line-of-sight between two or more of the wireless devices 218, which might obstruct or otherwise negative impact the transmission of wireless signals between them. Based on this determination, the wireless spectrum orchestrator module 202 can determine a new location for one of the wireless devices 218 such that a line-of-sight is exists between the wireless devices 218. For example, if a line-of-sight between a WAP 104 and a computing device 102 is blocked by a wall, door, window, pipe, conduit, item of furniture, and/or machinery, the wireless spectrum orchestrator module 202 can identify a new location for the WAP 104 and/or the computing device 102 such that a line-of-sight is exists between them.

In some implementations, the wireless network management system 150 can automatically perform the modifications identified by the wireless spectrum orchestrator module 202. For example, the wireless network management system 150 can use the control module 208 to generate commands to modify the network configuration of one or more of the wireless devices 218, and use the wireless transceiver 210 to transmit the command to the wireless devices 218 for execution.

In some implementations, the wireless spectrum orchestrator module 202 can present the modifications identified by the wireless spectrum orchestrator module 202 to a user and guide the user in performing the modifications manually. For example, the wireless network management system 150 can present a graphical user interface that includes instructions to perform the modifications (for example, a step-by-step set of instructions that can be followed by the user to change the network configurations antenna configurations, and/or locations of one or more of the wireless devices 218).

In the example shown in FIG. 1, a single wireless network management system 150 can manage each of devices on a wireless communications network. However, this need not be the case. For example, in some implementations, multiple wireless network management systems 150 can be used to manage devices on one more wireless communications networks concurrently.

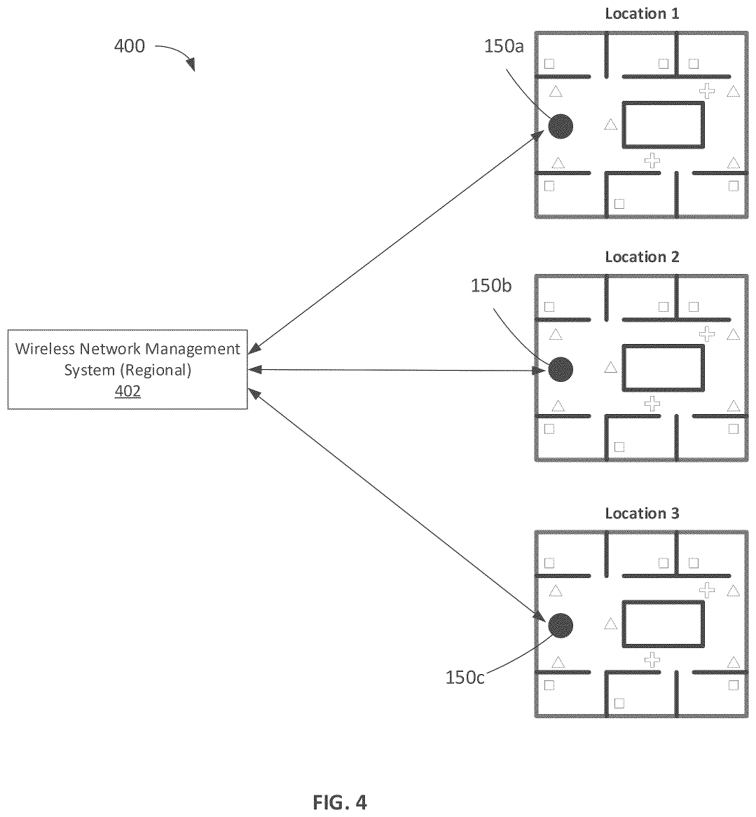

For instance, FIG. 4 shows an example system 400 for managing wireless devices in multiple locations. In this example, a first wireless network management system 150a is deployed at a Location 1, a second wireless network management system 150b is deployed at a different Location 2, and a third wireless network management system 150 is deployed at a different Location 3. In some implementations, the Locations 1-3 can represent different floors of a building, different wings of a building, different buildings in a site, or different sites entirely.

In some implementations, each of the wireless network management systems 150a-150b can perform a similar manner as described above (for example, with reference to FIGS. 1-3B). For example, each of the wireless network management systems 150a-150b can gather information regarding the wireless devices at its respective location, present the gathered information to one or more users, and manage the wireless devices at the respective location based on the gather information.

Further, a regional wireless network management system 402 can be communicatively coupled to each of the wireless network management systems 150a-150c (for example, via one or more wired and/or wireless links), and control the operation of each of the wireless network management systems 150a-150c. For example, the regional wireless network management system 402 can receive information gathered by wireless network management systems 150a-150c and present the gathered information to one or more users. Further, the regional wireless network management system 402 can manage the wireless devices at each of the locations based on the gather information. For example, the regional wireless network management system 402 can generate commands to modify the configurations of one or more of the wireless devices at any of the locations, and provide the commands to the wireless devices (either directly or via one of the wireless network management systems 150a-150c as an intermediary. As another example, the regional wireless network management system 402 generate instructions to a user to assist in the modification of the configurations of one or more of the wireless devices at any of the locations, and present the instructions to the user (for example, using a graphical user interface).

Although FIG. 4 shows an example system 400 having three wireless network management systems 150a-150c and a single regional wireless network management systems 402, this need always be the case. In practice, a system can include any number of wireless network management systems and regional wireless network management systems working in concert with one another to manage the operation of any number of wireless devices in any number of locations.

In a system such as system 150, multiple WAPs may each correspond to a different wireless communication protocols and communicate data pursuant to their corresponding protocols. These wireless communication protocols can include, e.g., International Society of Automation (ISA) 100.11a, WirelessHART, WI-FI, Long-Range Wide Area Network (LoRaWAN), or 5th Generation (5G). Some of these wireless communication protocols support wireless communications in a wireless local area network (WLAN), which geographically covers a relatively limited area, while some of these wireless communication protocols support wireless communications in a wireless wide area network (WWAN) or a long-haul network, which geographically cover a broader area. Currently, each of these protocols or networks can have its own hardware infrastructure, and it is costly and effort-consuming to exchange data across protocols or networks using equipment such as end-to-end Ethernet cables. Accordingly, it is desirable to have an integrated platform that supports interconnectivity between different communication protocols and network types.

Some implementations of this disclosure provide such an integrated platform. As described below, the platform integrates multiple WAPs to compact hardware, converts data under different communication protocols to support interconnectivity, and uses a data diode to control the data flows between the WAPs. The platform can be used in many applications, such as edge computing for industrial facility management, to provide efficient and secure data processing.

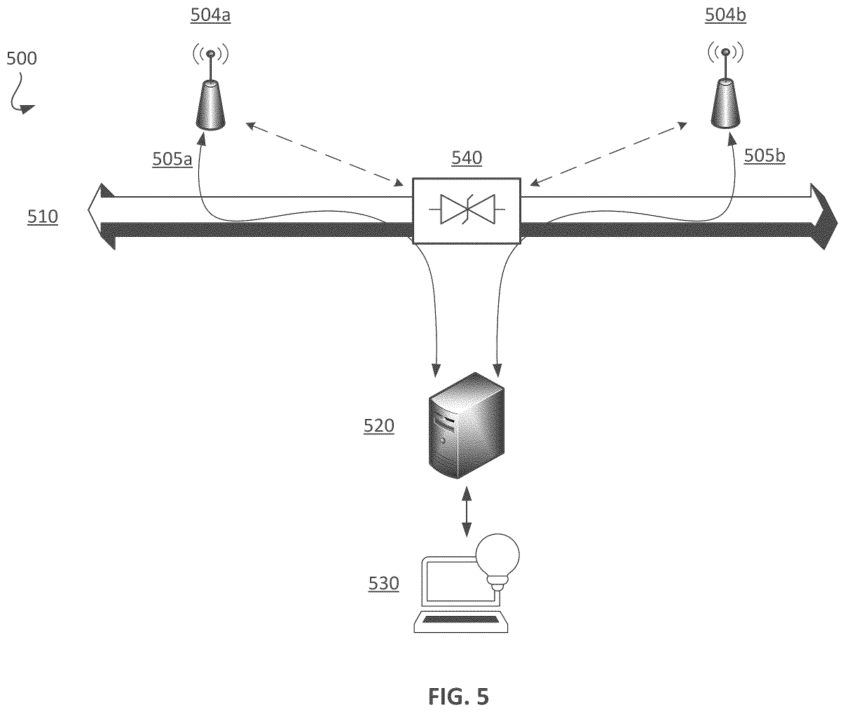

FIG. 5 illustrates a system architecture of an example integrated wireless platform 500. The platform 500 can be implemented, e.g., as part of the wireless network management system 150 of FIGS. 1 and 2.

The platform 500 has a plurality of WAPs 504a and 504b. In scenarios where the platform 500 is implemented as part of the wireless network management system 150, the WAPs 504a and 504b can be some or all of WAPs 104a-104d, which are physically integrated with the hardware of the platform 500. The WAPs 504a and 504b can correspond to different wireless communication protocols and are configured to communicate data pursuant to different wireless standards for different types of networks. For example, the WAP 504a can be a WI-FI access point to support a WI-FI WLAN, while the WAP 504b can be a 5G access point to support a cellular WWAN.

The platform 500 has a communication bus 510, such as an optical bus, that couples the WAPs 504a and 504b to a wireless local network server 520. The WAPs 504a and 504b can each have coupling circuitry configured to implement an international standard application programming interface (API), such as Open Platform Communications Universal Access (OPC UA), Message Queuing Telemetry Transport (MQTT), or Data Distribution Service (DDS). Data received by the WAPs 504a and 504b can be separately routed on the communication bus 510 as data flows 505a and 505b, respectively, to the wireless local network server 520 along the communication bus 510. Similarly, data to be transmitted by the WAPs 504a and 504b can be separately routed as data flows 505a and 505b, respectively, from the server 520 along the communication bus 510. The data on the data flows 505a and 505b can be formatted to comply with the communication protocols corresponding to the WAPs 504a and 504b, respectively.

The wireless local network server 520 is under the control of a processor 530, which can include a common high computing central processing unit (CHCCP). Although the processor 530 and the wireless local network server 520 are illustrated and described as separate elements, in some implementations the processor 530 and the wireless local network server 520 can be functionally and/or physically integrated to use the same software and/or hardware. By itself or along with the processor 530, the wireless local network server 520 can convert the data received from the data flows 505a and 505b according to a locally-configured protocol, such as a universal Open Process Automation (OPA) protocol. For example, the wireless local network server 520 can convert WI-FI data received from the data flow 505a to a format according to a local protocol specified by the processor 530 and pass the converted data to the processor 530 for edge computing. After the computing, the processor 530 can control the wireless local network server 520 to convert the computing results formatted under the local protocol to 5G cellular data and send the 5G cellular data to the WAP 504b for transmission. This way, data exchange between a WI-FI WAP and a 5G WAP is performed.

In the previous example, the local protocol can be the same as the 5G protocol. In such a case, the computing results generated by the processor 530 can be directly sent to the WAP 504b without a second conversion. In general, the processor 530 can dynamically, e.g., while in operation, determine which protocol to use as the local protocol based on the application, e.g., the computing task performed by the processor 530. For example, some protocols distinguish computing functions between those performed by a client (or device) and those performed by a server, and provide different data formats for client data and server data. Depending on whether the processor 530 and the wireless local network server 520 function as a server or a client under a particular protocol, the processor 530 can choose whether to use the particular protocol as the local protocol for data exchanges between different WAPs. When the function of the processor 530 and the wireless local network server 520 changes, the processor 530 can control the wireless local network server 520 to dynamically switch to use a different local protocol.

The platform 500 also has a data diode 540 implemented on the communication bus 510 and under the control of the processor 530. The processor 530 can control the data diode 540 to switch between a bidirectional mode and a unidirectional mode. In the bidirectional mode, the data diode 540 can allow data to flow bidirectionally between the WAPs 504a and 504b. In the unidirectional mode, the data diode 540 can allow data to flow unidirectionally, only from the WAP 504a to the WAP 504b or only from the WAP 504b to the WAP 504a. The data diode 540 can be implemented with, e.g., one or more electro-mechanical switches that correspond to one or more registers programmable by the processor 530.

The processor 530 can control the data diode 540 based on, e.g., a security policy. For example, when the WAP 504a possesses private data of a user whereas the WAP 504a possesses public data from the Internet, the processor 530 can control the data diode 540 to operate unidirectionally, allowing data to flow only from the WAP 504b to the WAP 504a. As another example, when the WAP 504a operates in a network that is more sensitive in nature (e.g., more prone to cyber-attacks) than the network in which the WAP 504b operates, the processor 530 can control the data diode 540 to, pursuant to a strict security policy, unidirectionally block the transfer of certain high-risk files, such as files having executable code or macros that could contain malware, from WAP 504b to WAP 504a. Conversely, the processor 530 can control the data diode 540 to, pursuant to a more lenient security policy, unidirectionally allow the transfer of some or all of the high-risk files from WAP 504a to WAP 504b.

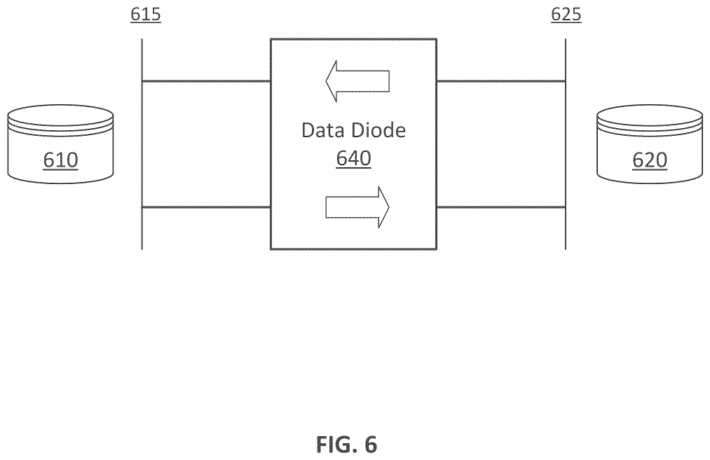

FIG. 6 illustrates example data flows between a data diode 640 and a plurality of network servers 610 and 620. The data diode 640 can be similar to the data diode 540 of FIG. 5. The network servers 610 and 620 can be configured to operate different types of networks, such as a WLAN and a WWAN, respectively.

The network servers 610 and 620 each have an interface, 615 and 625, respectively, that is coupled to the data diode 640 via a communication bus. Each of the interfaces 615 and 625 can be coupled to one or more WAPs that provide access to the network operated by the corresponding network server 610 and 620, respectively. For example, when deployed in the platform 500 of FIG. 5, the network server 610 can be configured to operate a WLAN under the WI-FI protocol, accessible to the WAP 504a via the interface 615. Likewise, the network server 620 can be configured to operate a WWAN under the 5G protocol, accessible to the WAP 504b via the interface 625. With this setting, the platform 500 can support secured data exchange not only across different WAPs but also across different types of networks.

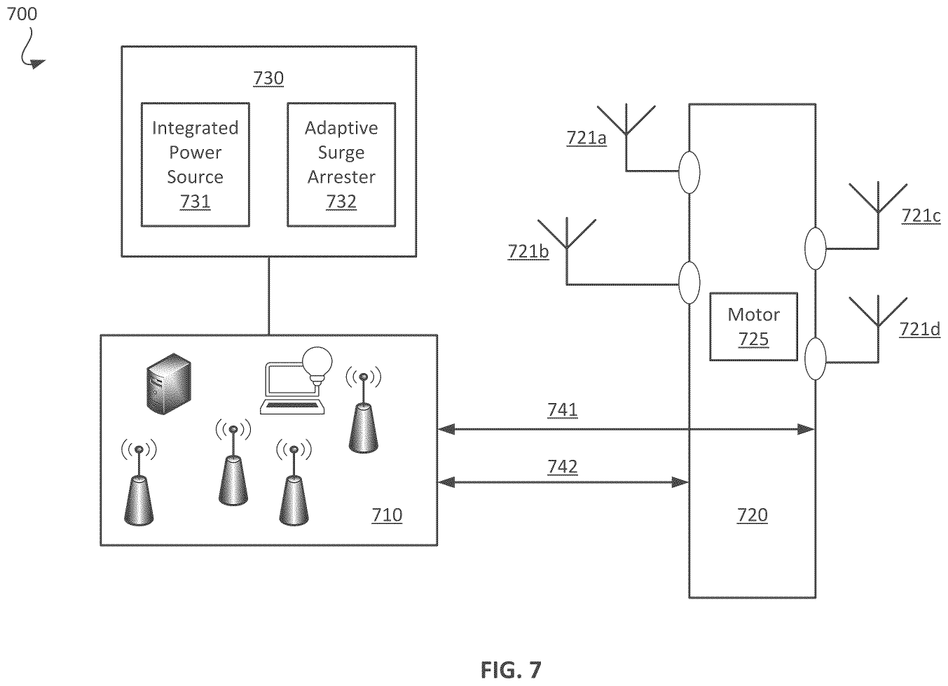

FIG. 7 illustrates an architecture 700 of an example integrated wireless platform 710 implemented with a power management module 730 and an antenna tower 720. The platform 710 can be similar to the platform 500 of FIG. 5.

The platform 710 can be powered by the power management module 730. The power management module 730 has an integrated power source 731, which can provide power to some or all components of the platform 710, such as the WAPs, the data diode, and the wireless local network server. The integrated power source 731 can have multiple pieces of power source circuitry that each separately feed power to a WAP, or can have a single piece of power source circuitry that feeds power to all WAPs. Having separate power feeds to the WAPs can prevent the platform 710 from complete outage when only one or a few power feeds break down (e.g., due to lightning strike or grounding faults). On the other hand, having a single power feed to all WAPs can reduce the size of the power management module 730. The power management module 730 also has an adaptive surge arrester 732 configured to provide surge protection to the platform 710.

The platform 710 can be coupled to an antenna facility 720, which can be similar to antennas 212 or 216 of FIG. 2. The antenna facility 720 can include an antenna tower or an antenna pole with one or more antenna elements installed. For example, the WAPs of the platform 710 can be coupled to the antenna facility 720 using a single cable or multiple cables 741 and 742. In some implementations where the WAPs correspond to multiple networks, multiple cables can be used to respectively couple the WAPs of a network to the antenna facility 720. For example, the cable 741 can be coupled to the WAPs of a WLAN, whereas the cable 742 can be coupled to the WAPs of a WWAN.

The antenna facility 720 can have one or more antenna elements 721a-721d (each individually referred to as antenna element 721) installed on an antenna pole. Each of the antenna elements 721a-721d can be designated for one or more specific WAPs, e.g., configured to transmit or receive radio waves from or to the specific WAP(s).

The position and/or orientation of each antenna element 721 can be adjusted. For example, the antenna facility 720 can have one or more motors 725 configured to change the vertical and/or horizontal positions of each antenna element 721 on the antenna facility 720, as well as the azimuth of each antenna element 721.

The adjustment of an antenna element 721 can be based on the communication quality. For example, the processor of the platform 710 can conduct diagnostic computing for a WAP and the corresponding antenna element to determine quality metrics, such as received signal strength and bit error rate. The processor can then use the diagnostic computing results to adjust the position and/or orientation of the antenna element 721 to improve communication quality.

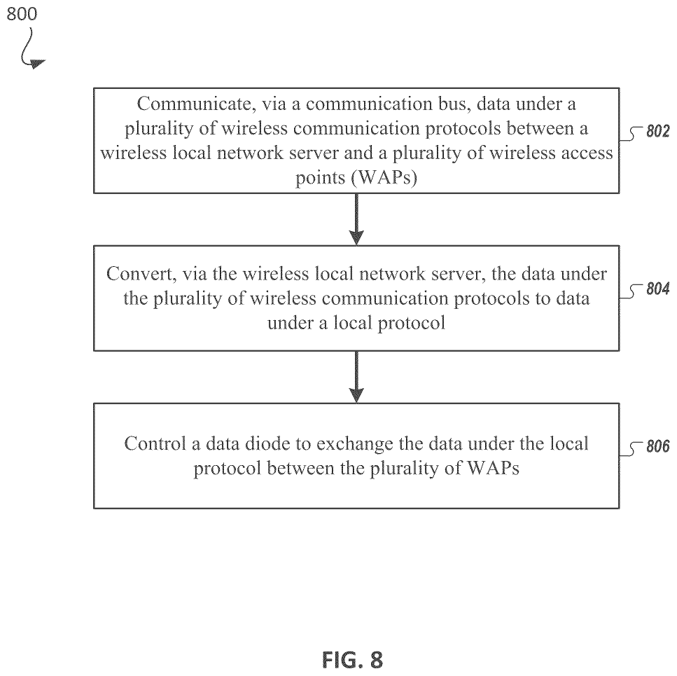

FIG. 8 is a flowchart of an example method 800. The method 800 can be executed by, e.g., the platform 500 of FIG. 5, the platform 700 of FIG. 7, or any other suitable devices or systems.

At 802, method 800 involves communicating, via a communication bus, data under a plurality of wireless communication protocols between a wireless local network server and a plurality of WAPs. The communication can be similar to the data flows 505a and 505b of FIG. 5. The wireless communication protocols can include, e.g., ISA 10.11a, WirelessHART, WI-FI, LoRaWAN, or 5G.

At 804, method 800 involves converting, via the wireless local network server, the data under the plurality of wireless communication protocols to data under a local protocol. The data conversion can be similar to the operations of the wireless local network server 520, as described with reference to FIG. 5.

At 806, method 800 involves controlling a data diode to exchange the data under the local protocol between the plurality of WAPs. The operations of the data diode can be similar to the operations of the data diode 540 or the data diode 640, as described with reference to FIGS. 5 and 6.

Some implementations of the subject matter and operations described in this specification can be implemented in digital electronic circuitry, or in computer software, firmware, or hardware, including the structures disclosed in this specification and their structural equivalents, or in combinations of one or more of them. For example, in some implementations, one or more components of the system 100 and wireless network management system 150 can be implemented using digital electronic circuitry, or in computer software, firmware, or hardware, or in combinations of one or more of them. In another example, the process 800 shown in FIG. 8 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, that is, one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (for example, multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer can also include, or be operatively coupled to receive data from or transfer data to, or both, one or more mass storage devices for storing data, for example, magnetic, magneto optical disks, or optical disks. However, a computer need not have such devices. Devices suitable for storing computer program instructions and data include all forms of non-volatile memory, media and memory devices, including by way of example semiconductor memory devices (for example, EPROM, EEPROM, AND flash memory devices), magnetic disks (for example, internal hard disks, and removable disks), magneto optical disks, and CD-ROM and DVD-ROM disks. The processor and the memory can be supplemented by, or incorporated in, special purpose logic circuitry.

To provide for interaction with a user, operations can be implemented on a computer having a display device (for example, a monitor, or another type of display device) for displaying information to the user. The computer can also include a keyboard and a pointing device (for example, a mouse, a trackball, a tablet, a touch sensitive screen, or another type of pointing device) by which the user can provide input to the computer. Other kinds of devices can be used to provide for interaction with a user as well. For example, feedback provided to the user can be any form of sensory feedback, such as visual feedback, auditory feedback, or tactile feedback. Input from the user can be received in any form, including acoustic, speech, or tactile input. In addition, a computer can interact with a user by sending documents to and receiving documents from a device that is used by the user. For example, a computer can send webpages to a web browser on a user's client device in response to requests received from the web browser.

A computer system can include a single computing device, or multiple computers that operate in proximity or generally remote from each other and typically interact through a communication network. Examples of communication networks include a local area network (“LAN”) and a wide area network (“WAN”), an inter-network (for example, the Internet), a network including a satellite link, and peer-to-peer networks (for example, ad hoc peer-to-peer networks). A relationship of client and server can arise by virtue of computer programs running on the respective computers and having a client-server relationship to each other.

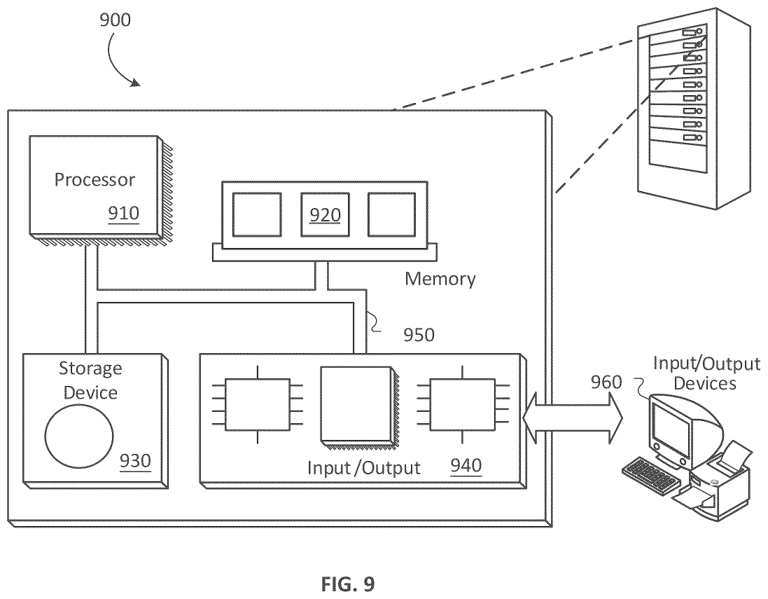

FIG. 9 shows an example computer system 900 that includes a processor 910, a memory 920, a storage device 930 and an input/output device 940. Each of the components 910, 920, 930 and 940 can be interconnected, for example, by a system bus 950. The processor 910 is capable of processing instructions for execution within the system 900. In some implementations, the processor 910 is a single-threaded processor, a multi-threaded processor, or another type of processor. The processor 910 is capable of processing instructions stored in the memory 920 or on the storage device 930. The memory 920 and the storage device 930 can store information within the system 900.

The input/output device 940 provides input/output operations for the system 900. In some implementations, the input/output device 940 can include one or more of a network interface device, for example, an Ethernet card, a serial communication device, for example, an RS-232 port, or a wireless interface device, for example, an 802.11 card, a 3G wireless modem, a 4G wireless modem, or a 5G wireless modem, or both. In some implementations, the input/output device can include driver devices configured to receive input data and send output data to other input/output devices, for example, keyboard, printer and display devices 960. In some implementations, mobile computing devices, mobile communication devices, and other devices can be used.

### EXAMPLES

In an example implementation, a system includes: a plurality of wireless access points (WAPs) corresponding to a plurality of wireless communication protocols; a wireless local network server coupled to the plurality of WAPs via a communication bus, wherein the wireless local network server is configured to convert data under the plurality of wireless communication protocols to data under a local protocol; a data diode communicatively coupled to the communication bus; and a processor configured to control the data diode to exchange the data under the local protocol between the plurality of WAPs.

In an aspect combinable with the example implementation, the plurality of WAPs include at least one of: a wireless local area network (WLAN) WAP, or a wireless wide area network (WWAN) WAP.

In another aspect combinable with any of the previous aspects, the plurality of wireless communication protocols include at least one of: International Society of Automation (ISA) 100.11a, WirelessHART, WI-FI, Long-Range Wide Area Network (LoRaWAN), or 5th Generation (5G) cellular protocol.

In another aspect combinable with any of the previous aspects, the local protocol includes a Universal Open Process Automation (OPA) protocol.

In another aspect combinable with any of the previous aspects, the processor is configured to perform edge computing based on the data under the local protocol.

In another aspect combinable with any of the previous aspects, the processor is configured to control the wireless local network server to dynamically switch between a server function and a client function based on the data under the local protocol.

In another aspect combinable with any of the previous aspects, the communication bus includes an optical bus.

In another aspect combinable with any of the previous aspects, the system further includes an electro-mechanical switch coupled to the data diode, wherein the processor is configured to control the electro-mechanical switch to turn the data diode between a unidirectional mode and a bidirectional mode based on a security policy.

In another aspect combinable with any of the previous aspects, the system further includes an antenna pole driven by a motor, wherein the antenna pole includes a plurality of antenna elements corresponding to the plurality of WAPs, wherein the processor is configured to control the motor to change a position of at least one antenna element of the plurality of antenna elements.

In another aspect combinable with any of the previous aspects, the system further includes: a power management module having a surge arrester configured to provide surge protection; and an integrated power source configured to feed power to the plurality of WAPs, wherein the integrated power source has a single piece of power source circuitry or multiple pieces of power source circuitry.

In an example implementation, a method includes: communicating, via a communication bus, data under a plurality of wireless communication protocols between a wireless local network server and a plurality of wireless access points (WAPs); converting, via the wireless local network server, the data under the plurality of wireless communication protocols to data under a local protocol; and controlling a data diode to exchange the data under the local protocol between the plurality of WAPs.

In an aspect combinable with the example implementation, the plurality of WAPs include at least one of: a wireless local area network (WLAN) WAP, or a wireless wide area network (WWAN) WAP.

In another aspect combinable with any of the previous aspects, the plurality of wireless communication protocols include at least one of: International Society of Automation (ISA) 100.11a, WirelessHART, WI-FI, Long-Range Wide Area Network (LoRaWAN), or 5th Generation (5G) cellular protocol.

In another aspect combinable with any of the previous aspects, the local protocol includes a Universal Open Process Automation (OPA) protocol.

In another aspect combinable with any of the previous aspects, the method further includes performing edge computing based on the data under the local protocol.

In another aspect combinable with any of the previous aspects, the method further includes controlling the wireless local network server to dynamically switch between a server function and a client function based on the data under the local protocol.

In another aspect combinable with any of the previous aspects, the communication bus includes an optical bus.

In another aspect combinable with any of the previous aspects, the method further includes controlling an electro-mechanical switch to turn the data diode between a unidirectional mode and a bidirectional mode based on a security policy.

In another aspect combinable with any of the previous aspects, the method further includes: performing wireless communications using an antenna pole driven by a motor, wherein the antenna pole includes a plurality of antenna elements corresponding to the plurality of WAPs; and controlling the motor to change a position of at least one antenna element of the plurality of antenna elements.

In an example implementation, an apparatus includes: a wireless local network server coupled to a plurality of wireless access points (WAPs) via a communication bus, wherein the plurality of WAPs correspond to a plurality of wireless communication protocols, and wherein the wireless local network server is configured to convert data under the plurality of wireless communication protocols to data under a local protocol; a data diode communicatively coupled to the communication bus; and a processor configured to control the data diode to exchange the data under the local protocol between the plurality of WAPs.

In an aspect combinable with the example implementation, the plurality of WAPs include at least one of: a wireless local area network (WLAN) WAP, or a wireless wide area network (WWAN) WAP.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple implementations separately or in any suitable sub-combination.

A number of implementations have been described. Nevertheless, various modifications can be made without departing from the spirit and scope of the invention. Accordingly, other implementations are within the scope of the claims.

What is claimed is:

1. A system comprising:
a plurality of wireless access points (WAPs) corresponding to a plurality of wireless communication protocols;
a wireless local network server coupled to the plurality of WAPs via a communication bus, wherein the wireless local network server is configured to convert data under the plurality of wireless communication protocols to data under a local protocol;
a data diode communicatively coupled to the communication bus; and
a processor configured to control the data diode to exchange the data under the local protocol between the plurality of WAPs.

2. The system of claim 1, wherein the plurality of WAPs comprise at least one of: a wireless local area network (WLAN) WAP, or a wireless wide area network (WWAN) WAP.

3. The system of claim 1, wherein the plurality of wireless communication protocols comprise at least one of:
International Society of Automation (ISA) 100.11a,
WirelessHART,
WI-FI,
Long-Range Wide Area Network (LoRaWAN), or
5th Generation (5G) cellular protocol.

4. The system of claim 1, wherein the local protocol comprises a Universal Open Process Automation (OPA) protocol.

5. The system of claim 1, wherein the processor is configured to perform edge computing based on the data under the local protocol.

6. The system of claim 1, wherein the processor is configured to control the wireless local network server to dynamically switch between a server function and a client function based on the data under the local protocol.

7. The system of claim 1, wherein the communication bus comprises an optical bus.

8. The system of claim 1, further comprising an electro-mechanical switch coupled to the data diode, wherein the processor is configured to control the electro-mechanical switch to turn the data diode between a unidirectional mode and a bidirectional mode based on a security policy.

9. The system of claim 1, further comprising an antenna pole driven by a motor, wherein the antenna pole comprises a plurality of antenna elements corresponding to the plurality of WAPs, wherein the processor is configured to control the motor to change a position of at least one antenna element of the plurality of antenna elements.

10. The system of claim 1, further comprising:
a power management module having a surge arrester configured to provide surge protection; and
an integrated power source configured to feed power to the plurality of WAPs, wherein the integrated power source has a single piece of power source circuitry or multiple pieces of power source circuitry.

11. A method comprising:
communicating, via a communication bus, data under a plurality of wireless communication protocols between a wireless local network server and a plurality of wireless access points (WAPs);
converting, via the wireless local network server, the data under the plurality of wireless communication protocols to data under a local protocol; and
controlling a data diode to exchange the data under the local protocol between the plurality of WAPs.

12. The method of claim 11, wherein the plurality of WAPs comprise at least one of: a wireless local area network (WLAN) WAP, or a wireless wide area network (WWAN) WAP.

13. The method of claim 11, wherein the plurality of wireless communication protocols comprise at least one of:
International Society of Automation (ISA) 100.11a,
WirelessHART,
WI-FI,
Long-Range Wide Area Network (LoRaWAN), or
5th Generation (5G) cellular protocol.

14. The method of claim 11, wherein the local protocol comprises a Universal Open Process Automation (OPA) protocol.

15. The method of claim 11, further comprising performing edge computing based on the data under the local protocol.

16. The method of claim 11, further comprising controlling the wireless local network server to dynamically switch between a server function and a client function based on the data under the local protocol.

17. The method of claim 11, wherein the communication bus comprises an optical bus.

18. The method of claim 11, further comprising controlling an electro-mechanical switch to turn the data diode between a unidirectional mode and a bidirectional mode based on a security policy.

19. The method of claim 11, further comprising:
performing wireless communications using an antenna pole driven by a motor, wherein the antenna pole comprises a plurality of antenna elements corresponding to the plurality of WAPs; and
controlling the motor to change a position of at least one antenna element of the plurality of antenna elements.

20. An apparatus comprising:
a wireless local network server coupled to a plurality of wireless access points (WAPs) via a communication bus, wherein the plurality of WAPs correspond to a plurality of wireless communication protocols, and wherein the wireless local network server is configured to convert data under the plurality of wireless communication protocols to data under a local protocol;
a data diode communicatively coupled to the communication bus; and
a processor configured to control the data diode to exchange the data under the local protocol between the plurality of WAPs.
